(19) United States
(12) Patent Application Publication
(10) Pub. No.: US 2025/0100411 A1
(43) Pub. Date: Mar. 27, 2025

(54) VEHICLE CHARGING DEVICE

(71) Applicants: YAZAKI CORPORATION, Tokyo (JP); ShinMaywa Industries, Ltd., Takarazuka-shi, Hyogo (JP)

(72) Inventors: Yukinari Naganishi, Susono-shi (JP); Shigeru Yoneda, Susono-shi (JP); Takashi Shiroki, Susono-shi (JP); Nobuo Yoneyama, Takarazuka-shi (JP); Hajime Ojiro, Takarazuka-shi (JP); Kouhei Ootsuka, Takarazuka-shi (JP); Koji Ikegaya, Susono-shi (JP); Suguru Sakamoto, Makinohara-shi (JP)

(21) Appl. No.: 18/886,996

(22) Filed: Sep. 16, 2024

(30) Foreign Application Priority Data
Sep. 21, 2023 (JP) 2023-154100
Oct. 24, 2023 (JP) 2023-182786

(51) Int. Cl. B60L 53/37; B60L 53/16

(52) U.S. Cl. CPC B60L 53/37; B60L 53/16

(57) ABSTRACT

A vehicle charging device includes: a connector that includes a groove part guided by a linear protrusion of an inlet; a support member; a connection mechanism; an arm that includes a first end part connected to the support member and a second end part supported in a rotatable manner; a first drive mechanism that moves the arm in a first direction; a second drive mechanism that moves the arm in a second direction; a third drive mechanism that rotates the arm; a fourth drive mechanism that changes an angle of the connector; a sensor that detects the inlet; and a controller.

### CROSS-REFERENCE TO RELATED APPLICATION(S)

The present application claims priority to and incorporates by reference the entire contents of Japanese Patent Application No. 2023-154100 filed in Japan on Sep. 21, 2023 and Japanese Patent Application No. 2023-182786 filed in Japan on Oct. 24, 2023.

### BACKGROUND OF THE INVENTION

### 1. Field of the Invention

The present invention relates to a vehicle charging device.

### 2. Description of the Related Art

Conventionally, there are charging devices for charging vehicles. The vehicle charging system disclosed in Japanese Patent Application Laid-open No. 2022-26379 includes a power supply device that has a power supply fitting body and is installed in a parking space of a vehicle. The vehicle charging system has an insertion/extraction direction moving part that allows the power supply fitting body to be fitted into a power reception fitting body of the vehicle.

There may be variations in the parking position of a vehicle, the orientation of the vehicle, and the like. There is a need for technology that allows a connector to be properly fitted into an inlet of the vehicle even with such variations.

### SUMMARY OF THE INVENTION

An object of the present invention is to provide a vehicle charging device that allows a connector to be properly fitted into an inlet of a vehicle.

A vehicle charging device according to one aspect of the present invention includes a connector that includes a groove part guided by a linear protrusion provided to an inlet disposed in a vehicle, the connector being fitted into the inlet; a support member; a connection mechanism that connects the connector and the support member, and allows a change in a posture of the connector; an arm that includes a first end part connected to the support member and a second end part supported in a rotatable manner, the arm moving up and down the support member by rotating; a first drive mechanism that moves the arm in a horizontal first direction; a second drive mechanism that moves the arm in a horizontal second direction; a third drive mechanism that rotates the arm; a fourth drive mechanism that rotates the support member so as to change an angle of the connector with respect to the first direction; a sensor that detects the inlet; and a controller, wherein the first direction and the second direction are orthogonal to each other, the controller calculates a position of the protrusion in the first direction, the second direction, and an up-and-down direction based on information acquired from the sensor, and the controller controls the first drive mechanism, the second drive mechanism, the third drive mechanism, and the fourth drive mechanism based on the calculated position of the protrusion to fit the connector into the inlet along the first direction while inserting the protrusion of the inlet into the groove part of the connector.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a vehicle charging device according to an embodiment;

FIG. 2 is a perspective view of the vehicle charging device according to the embodiment;

FIG. 3 is a perspective view of the vehicle charging device according to the embodiment;

FIG. 4 is a side view of the vehicle charging device according to the embodiment;

FIG. 5 is a block diagram of the vehicle charging device according to the embodiment

FIG. 6 is a side view of an inlet scanned by a sensor;

FIG. 7 is a side view of the inlet scanned by the sensor;

FIG. 8 is a bottom view of the inlet scanned by the sensor;

FIG. 9 is a side view illustrating a pitch angle;

FIG. 10 is a bottom view of the inlet scanned by the sensor;

FIG. 11 is a front view illustrating a roll angle;

FIG. 12 is a bottom view of the inlet according to the embodiment;

FIG. 13 is a sectional view of the inlet and a connector;

FIG. 14 is a sectional view of the inlet and the connector;

FIG. 15 is a diagram of a vehicle charging device according to a first modification example of the embodiment;

FIG. 16 is a diagram illustrating scan lines according to a second modification example of the embodiment;

FIG. 17 is a diagram for describing scan lines according to a third modification example of the embodiment;

FIG. 18 is a diagram for describing a single scan;

FIG. 19 is a diagram for describing a next scan; and

FIG. 20 is a diagram illustrating detection points including a false detection point.

### DETAILED DESCRIPTION OF THE PREFERRED EMBODIMENTS

Hereinafter, a vehicle charging device according to an embodiment of the present invention will be described in detail with reference to the accompanying drawings. Note, however, that the present invention is not limited by the embodiment. Furthermore, structural components in the following embodiment include those that easily occur to those skilled in the art, or those that are substantially the same.

### Embodiment

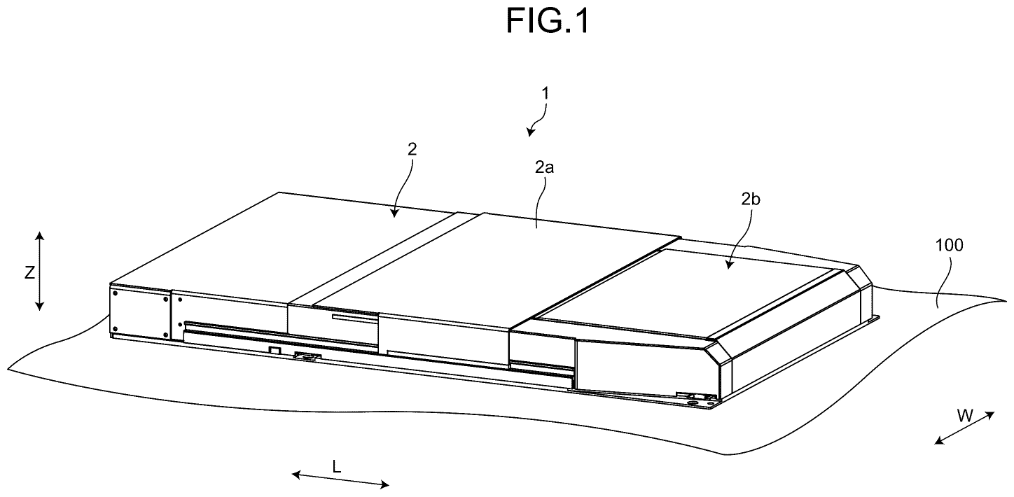

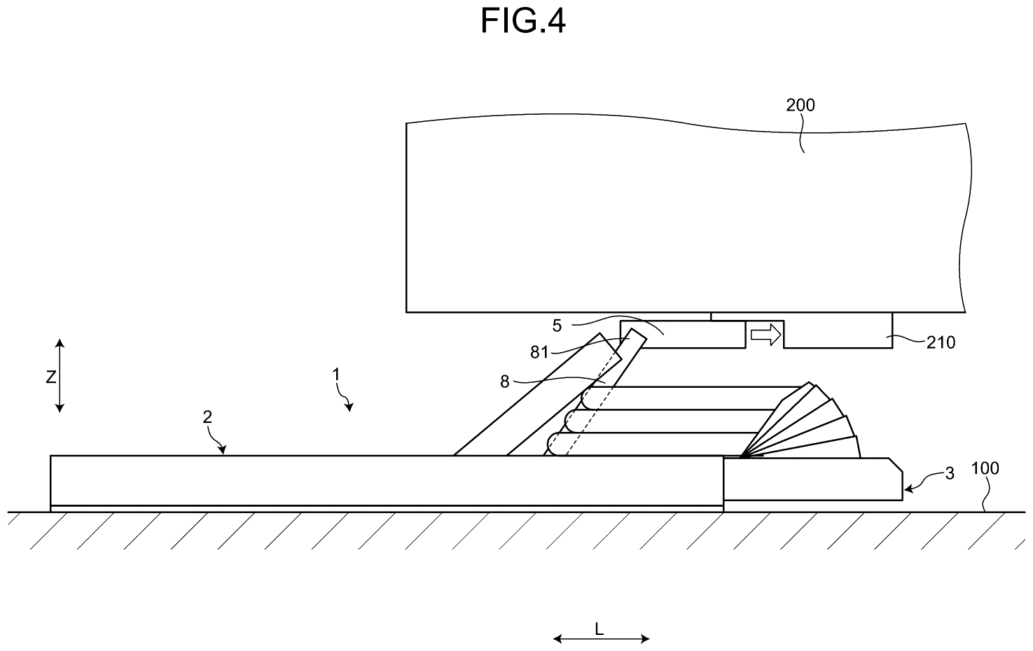

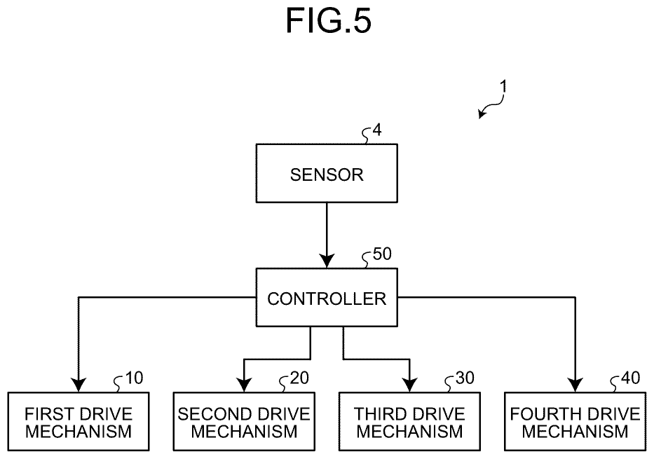

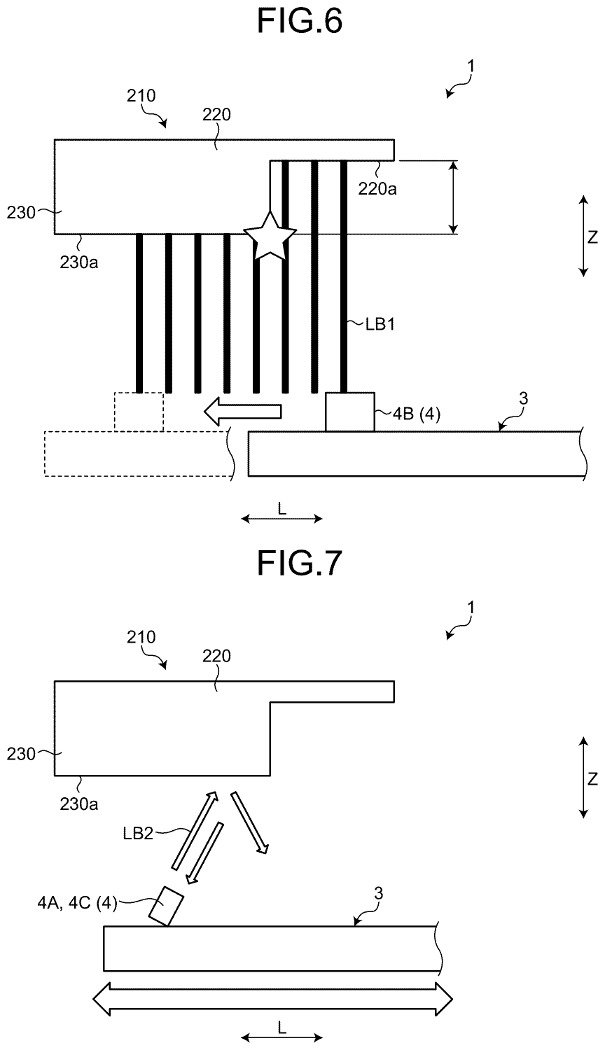

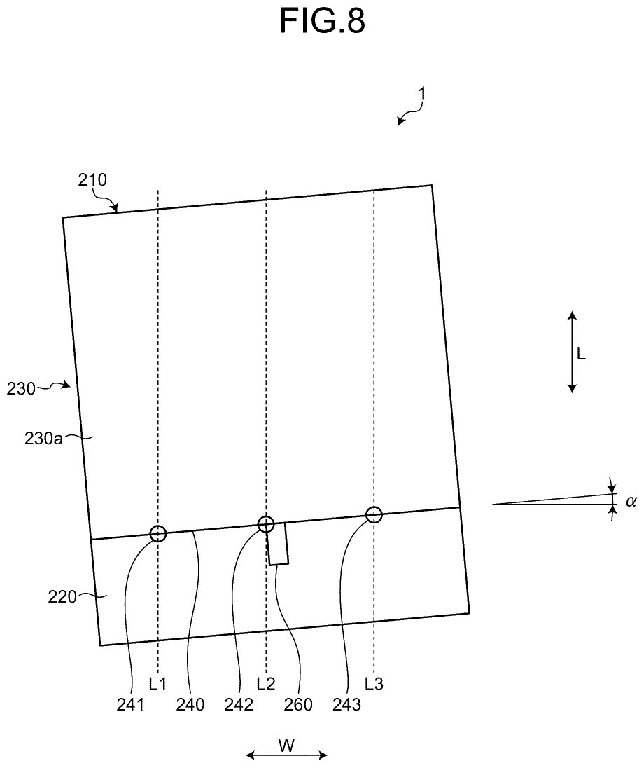

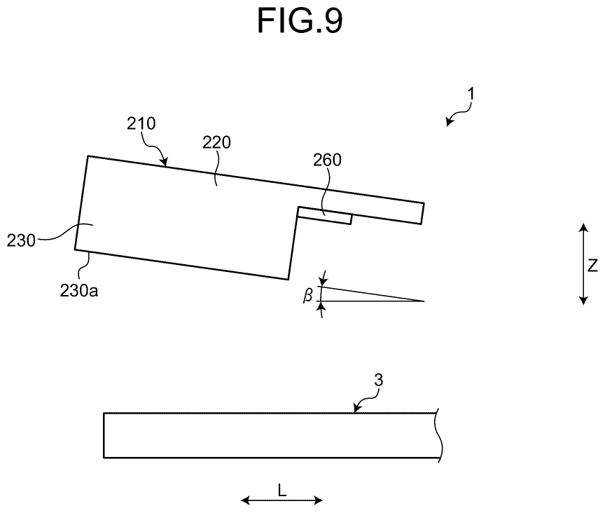

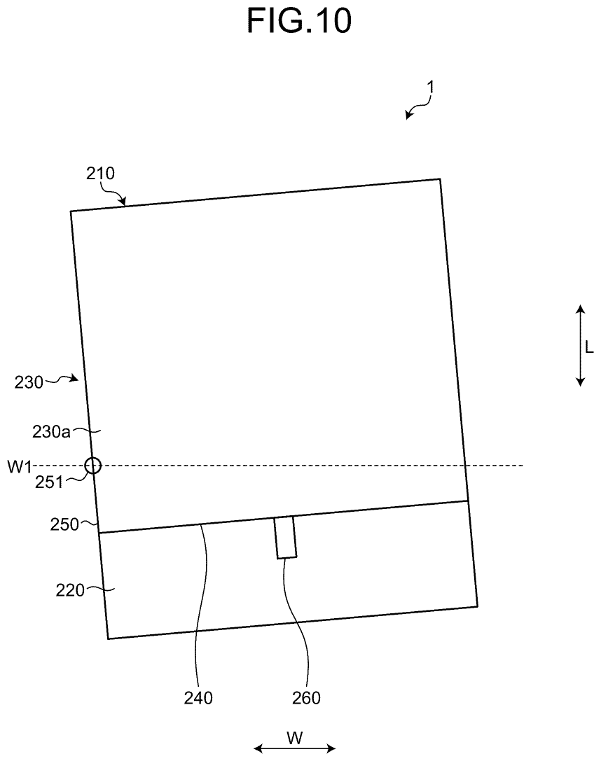

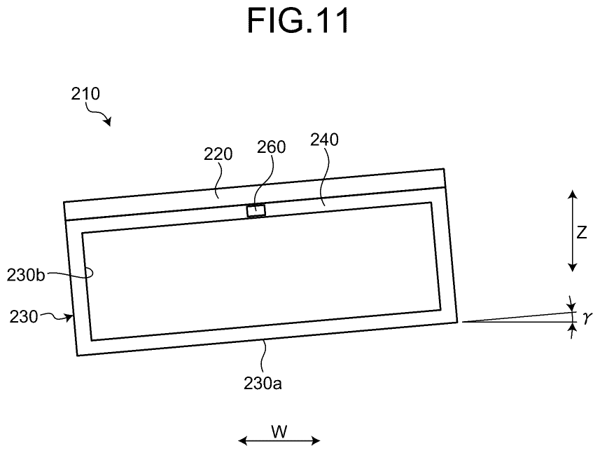

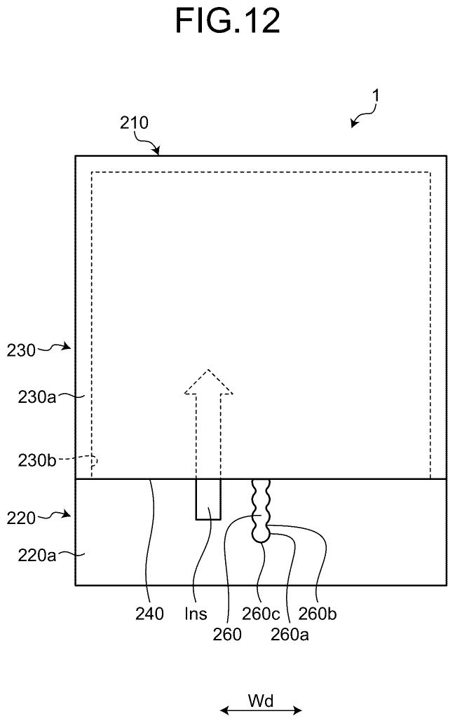

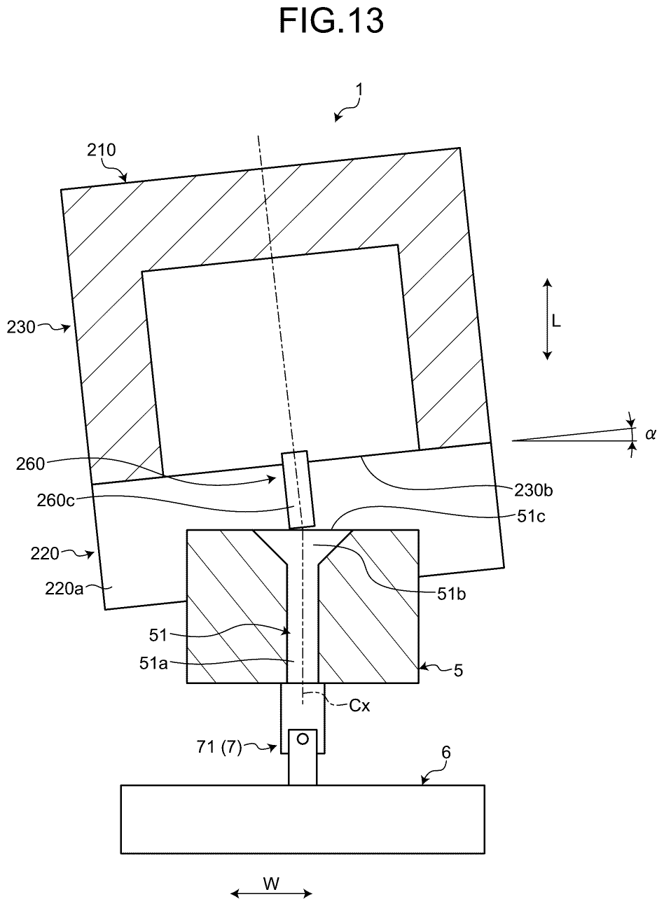

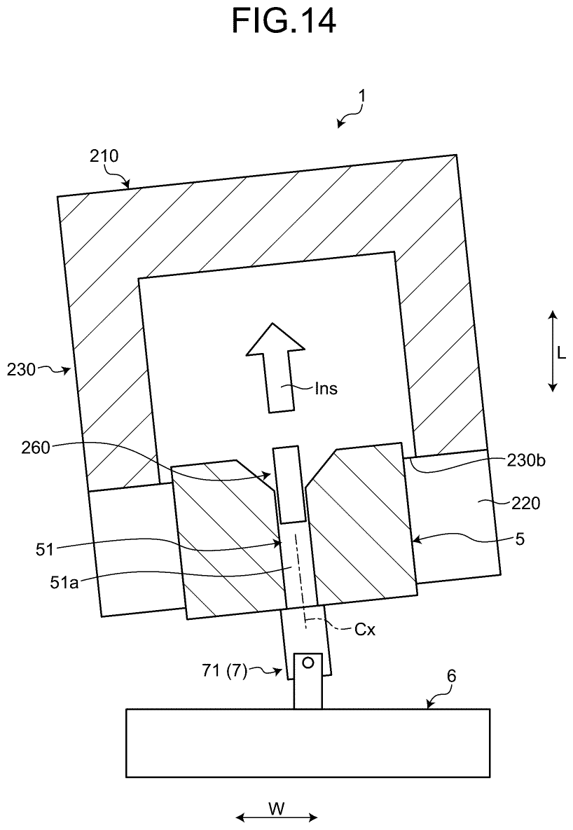

Referring to FIG. 1 through FIG. 14, the embodiment will be described. The present embodiment relates to a vehicle charging device. FIG. 1 to FIG. 3 are perspective views of the vehicle charging device according to the embodiment, FIG. 4 is a side view of the vehicle charging device according to the embodiment, FIG. 5 is a block diagram of the vehicle charging device according to the embodiment, FIG. 6 and FIG. 7 are side views of an inlet scanned by a sensor, FIG. 8 is a bottom view of the inlet scanned by the sensor, FIG. 9 is a side view illustrating a pitch angle, FIG. 10 is a bottom view of the inlet scanned by the sensor, FIG. 11 is a front view illustrating a roll angle, FIG. 12 is a bottom view of the inlet according to the embodiment, and FIG. 13 and FIG. 14 are sectional views of the inlet and a connector.

As illustrated in FIG. 1, a vehicle charging device 1 according to the present embodiment is disposed on a floor 100 of a parking space where a vehicle is to be parked. The vehicle charging device 1 includes a casing 2. The casing 2 is fixed to the floor 100. The casing 2 includes a slidable cover 2a and a rotatable cover 2b. The covers 2a and 2b cover the device housed in the interior space of the casing 2 from the top.

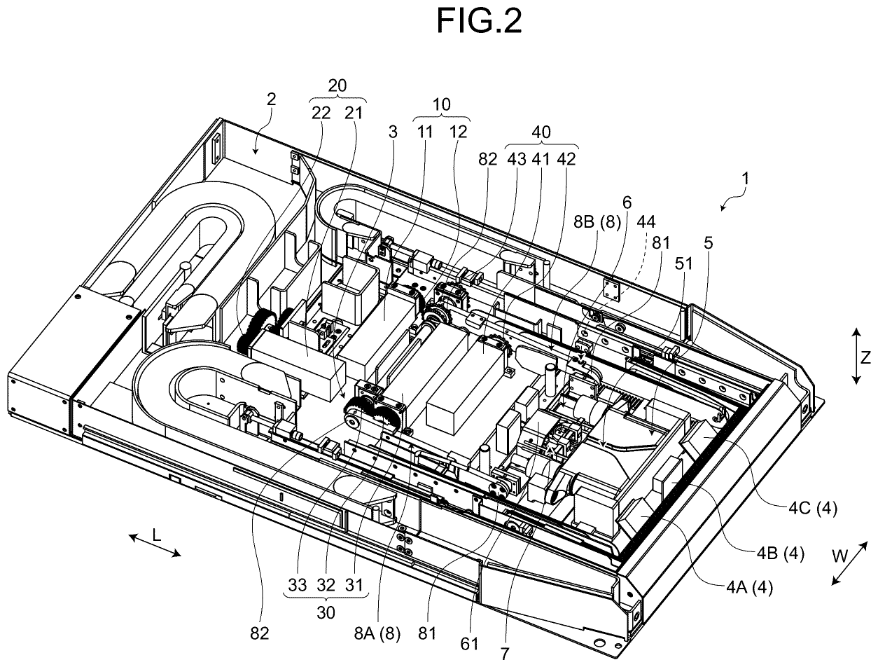

As illustrated in FIG. 2, the vehicle charging device 1 includes a slide body 3 disposed inside a casing 2. The slide body 3 is a plate-shaped base member that is movable in a first direction L and a second direction W with respect to the casing 2. The first direction L and the second direction W are horizontal directions. When the floor face of the floor 100 is sloped, the first direction L and the second direction W are preferable to be parallel to the floor face of the floor 100.

The first direction L corresponds to the front-and-rear direction of a vehicle 200 that is a charging target. The second direction W corresponds to the width direction of the vehicle 200. The vehicle 200 is moved forward or backward along the first direction L to be positioned at the charging position to be charged by the vehicle charging device 1. In the vehicle charging device 1 presented as an example, the first direction L is the longitudinal direction of the casing 2. The second direction W is the widthwise direction of the casing 2, and it is orthogonal to the first direction L.

The vehicle charging device 1 includes a sensor 4, a connector 5, a support member 6, a connection mechanism 7, and an arm 8. The vehicle charging device 1 further includes a first drive mechanism 10, a second drive mechanism 20, a third drive mechanism 30, and a fourth drive mechanism 40.

As illustrated in FIG. 4, the connector 5 is fitted into an inlet 210 disposed in the vehicle 200. The inlet 210 is disposed at the bottom part of the vehicle 200. The connector 5 is connected to a battery of the vehicle 200 by being fitted into the inlet 210.

The sensor 4 is used for detecting the position of the inlet 210. The sensor 4 may be a distance-measuring sensor, a sensor that captures an image and detects a target in the image, or any other position detection sensor. The sensor 4 may include a plurality of sensors with different detection methods. The sensor 4 according to the present embodiment is a laser sensor that detects the distance to a reflective object by using a laser beam. The sensor 4 emits a laser beam in a direction defined in advance and receives the laser beam reflected by the target.

The sensor 4 is disposed on the slide body 3, and moves along with the slide body 3. The sensor 4 illustrated in FIG. 2 includes a first sensor 4A, a second sensor 4B, and a third sensor 4C. The three sensors 4A, 4B, and 4C are disposed side by side in this order in the second direction W. The second sensor 4B emits a laser beam toward the upper side of an up-and-down direction Z. The up-and-down direction is a direction orthogonal to both the first direction L and the second direction W, and corresponds to the up-and-down direction of the vehicle 200. The first sensor 4A and the third sensor 4C emit laser beams in an oblique direction tilted with respect to the up-and-bottom direction Z.

The connector 5 is a charging connector for charging the battery of the vehicle 200. The connector 5 includes a terminal for charging. The vehicle charging device 1 according to the present embodiment is configured such that the position of the connector 5 can be moved in the first direction L, the second direction W, and the up-and-down direction Z.

The first drive mechanism 10 is a mechanism that moves the connector 5 in the first direction L. The first drive mechanism 10 includes a first motor 11 and a gearwheel 12, and it is provided in the slide body 3. The gearwheel 12 is disposed from an output shaft of the first motor 11 via a reduction gear, and meshes with a rack gear disposed on a plate-shaped intermediate body that slidably supports the slide body 3 in the first direction L underneath the slide body 3. The first motor 11 can move the slide body 3 in the first direction L with respect to the intermediate body by rotating forward and rotating reversely.

The second drive mechanism 20 is a mechanism that moves the connector 5 in the second direction W. The second drive mechanism 20 includes a second motor 21 and a gearwheel 22, and it is provided in the intermediate body. The gearwheel 22 is disposed on the output shaft of the second motor 21. Via a reduction gear, the gearwheel 22 meshes with a rack gear disposed in the casing 2 that slidably supports the intermediate body in the second direction W. The second motor 21 can move the intermediate body in the second direction W by rotating forward and rotating reversely.

The third drive mechanism 30 moves the connector 5 in the up-and-down direction Z. The connector 5 is connected to the slide body 3 via the arm 8, the support member 6, and the connection mechanism 7. The arm 8 is a plate-shaped member, and includes a first end part 81 and a second end part 82. The first end part 81 is connected to the support member 6. The second end part 82 is rotatably supported to the slide body 3. In other words, the arm 8 can rotate with the second end part 82 being the center of rotation. The arm 8 moves the support member 6 up and down by rotating.

The vehicle charging device 1 according to the present embodiment includes a first arm 8A and a second arm 8B. The first arm 8A and the second arm 8B extend in the first direction L, and face each other in the second direction W. The second end parts 82 of the two arms 8A and 8B are connected to each other via a shaft. Thus, the two arms 8A and 8B rotate in conjunction.

The support member 6 is connected to the first end part 81 of the first arm 8A and the first end part 81 of the second arm 8B. The support member 6 is a plate-shaped member, and extends in the second direction W. The support member 6 is axially supported by the first end parts 81 of the arms 8 so as to be able to rotate relative to the arms 8.

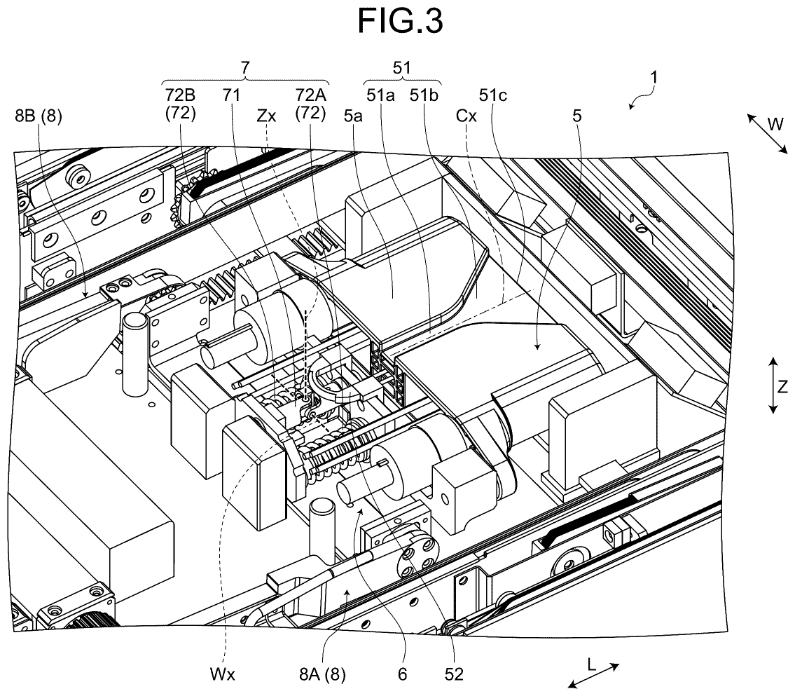

The connection mechanism 7 connects the connector 5 to the support member 6, and it is configured to allow changes in the posture of the connector 5. As illustrated in FIG. 3, the connection mechanism 7 includes a universal joint 71 and a spring 72. The universal joint 71 and the spring 72 are disposed between the support member 6 and the connector 5, and extend in the first direction L. One ends of the universal joint 71 and the spring 72 are connected to the support member 6, and the other ends of the universal joint 71 and the spring 72 are connected to the connector 5.

A bearing may be disposed between the universal joint 71 and the connector 5. In that case, the bearing allows rotation of the connector 5 with the central axis line in the first direction L being the center of rotation. When a bearing is provided, the connector 5 can rotate relative to the universal joint 71.

The universal joint 71 according to the present embodiment allows changes in the posture of the connector 5 in the two rotational directions. More specifically, the universal joint 71 allows rotation of the connector 5 with a central axis line Wx in the second direction W being the center of rotation. The universal joint 71 further allows rotation of the connector 5 with a central axis line Zx in the up-and-down direction Z being the center of rotation. The universal joint 71 is a cross joint, for example.

The spring 72 includes a first spring 72A and a second spring 72B. The first spring 72A and the second spring 72B are disposed on both sides of the second direction W with the universal joint 71 interposed therebetween. The first spring 72A and the second spring 72B apply a spring force on the connector 5 to return the position of the connector 5 to the neutral position in the rotational directions.

The third drive mechanism 30 moves the connector 5 in the up-and-down direction Z by rotating the arm 8. As illustrated in FIG. 2, the third drive mechanism 30 includes a third motor 31, a first gearwheel 32, and a second gearwheel 33. The first gearwheel 32 is disposed on the output shaft of the third motor 31. The second gearwheel 33 is connected to a shaft connecting the two arms 8A, 8B, and meshes with the first gearwheel 32. The third motor 31 rotates the arms 8 by rotating forward and rotating reversely.

The fourth drive mechanism 40 is configured to change an angle θ of the connector 5. The angle θ is the tilt angle of the connector 5 with respect to the first direction L. The fourth drive mechanism 40 includes a fourth motor 41, a first sprocket 42, and a pair of second sprockets 43. The first sprocket 42 is disposed on the output shaft of the fourth motor 41. The second sprockets 43 are coaxially disposed with the shaft connecting the arms 8A, 8B, and rotate relative to the shaft. An unbroken chain is passed around the first sprocket 42 and the second sprockets 43. A third sprocket 44 is disposed in the support member 6. An unbroken chain is passed around the second sprockets 43 and the third sprocket 44. The fourth motor 41 rotates the support member 6 relative to the arms 8A, 8B by rotating forward and rotating reversely. Rotation of the support member 6 changes the angle θ of the connector 5.

As illustrated in FIG. 2, a cover 61 is fixed to the support member 6. The cover 61 covers the end part of the connection mechanism 7 on the support member 6 side. As illustrated in FIG. 3, a U-shaped contact member 52 is fixed to the connector 5. The contact member 52 abuts against the cover 61 and is supported by the cover 61. The drive of the connector 5 is regulated by the cover 61 and the contact member 52. This regulatory structure transmits forces in the fitting direction to the connector 5 while allowing changes in the posture of the connector 5, when the connector 5 is fitted into the inlet 210, for example.

As illustrated in FIG. 4, the vehicle charging device 1 fits the connector 5 into the inlet 210 of the vehicle 200. As described hereinafter, the vehicle charging device 1 detects the position of the inlet 210 and the posture of the inlet 210 before fitting the connector 5 into the inlet 210. The vehicle charging device 1 fits the connector 5 into the inlet 210 while controlling the position of the connector 5 and the posture of the connector 5 based on the detection result.

FIG. 5 illustrates a block diagram of the vehicle charging device 1 according to the present embodiment. As illustrated in FIG. 5, the vehicle charging device 1 includes a controller 50. The controller 50 controls the sensor 4 and acquires the detection result of the sensor 4. The controller 50 also controls the first drive mechanism 10, the second drive mechanism 20, the third drive mechanism 30, and the fourth drive mechanism 40. The controller 50 calculates the position of the inlet 210 and the posture of the inlet 210 based on the detection result of the sensor 4.

FIG. 6 illustrates how the sensor 4 scans the inlet 210 in the present embodiment. As illustrated in FIG. 6, the inlet 210 includes a base part 220 and a fitting part 230. The base part 220 is the part that is fixed to the vehicle 200, and has a substantially flat plate shape. The fitting part 230 rises from the base part 220 toward the lower side in the up-and-down direction Z. The fitting part 230 has an opening part into which the connector 5 is inserted. A terminal is housed inside the fitting part 230. The fitting part 230 according to the present embodiment has a rectangular parallelepiped shape.

There is a step existing in the up-and-down direction Z between a bottom face 220a of the base part 220 and a bottom face 230a of the fitting part 230. Based on the step, the controller 50 calculates the position of the fitting part 230 and the position of a protrusion 260 described later. As illustrated in FIG. 6, the controller 50 causes the sensor 4 to emit laser beams LB while moving the slide body 3 in the first direction L. The sensor 4, for example, emits the laser beam LB at each position equally spaced along the first direction L to measure the distance to the target. FIG. 6 illustrates laser beams LB1 emitted from the second sensor 4B. The emission direction of the laser beams LB1 by the second sensor 4B is the up-and-down direction Z.

FIG. 7 illustrates a laser beam LB2 emitted from the first sensor 4A and the third sensor 4C. The laser beam LB2 is emitted in a direction tilted with respect to the up-and-down direction Z. Part of the laser beam LB2 is reflected by the inlet 210 toward first sensor 4A and third sensor 4C. The other part of the laser beam LB2 is reflected in a direction different from the sensor 4.

The vehicle charging device 1 includes the first sensor 4A, the second sensor 4B, and the third sensor 4C. Thereby, as illustrated in FIG. 8, the inlet 210 can be scanned along three lines L1, L2, and L3 at different positions in the second direction W. The three lines L1, L2, and L3 are equally spaced, for example.

The controller 50 detects the position of an end part 240 based on the detection results of the sensor 4. The end part 240 is the end part of the fitting part 230 in the first direction L. As illustrated in FIG. 11, the end part 240 has an opening part 230b into which the connector 5 is inserted. The controller 50 determines a point where the distance detected by the sensor 4 changes significantly as the end part 240.

As illustrated in FIG. 8, a position 241 of the end part 240 intersecting with the first line L1, a position 242 of the end part 240 intersecting with the second line L2, and a position 243 of the end part 240 intersecting with the third line L3 are acquired. The controller 50 calculates the coordinate values of the positions 241, 242, and 243 in each of the directions L, W, and Z, for example. The controller 50 calculates a yaw angle α of the inlet 210 based on the coordinate values of the positions 241, 242, and 243. The yaw angle α is the rotation angle of the vehicle 200 and the inlet 210 with the line in the up-and-down direction Z being the center of rotation. The yaw angle α is also the tilt angle of the end part 240 with respect to the second direction W.

The controller 50 also calculates a pitch angle β of the inlet 210 based on the detection result of the sensor 4. As illustrated in FIG. 9, the pitch angle β is the tilt angle of the inlet 210 with respect to the first direction L. The pitch angle β is also the rotation angle of the vehicle 200 and the inlet 210 with the line in the second direction W being the center of rotation.

FIG. 10 illustrates a line W1 to be scanned along the second direction W. The controller 50 scans the inlet 210 by the sensor 4 along the line W1. The position of the line W1 in the first direction L is set based on the detected positions 241, 242, and 243, for example. The line W1 is set to intersect with the fitting part 230. The controller 50 causes the sensor 4 to scan the inlet 210 while moving the slide body 3 in the second direction W.

The controller 50 calculates an end part 250 of the inlet 210 based on the result of the scan performed along the line W1. The end part 250 is the end part of the fitting part 230 in the second direction W. In the end part 250, there is a step between the bottom face 230a and the base part 220. The controller 50 determines a point where the distance detected by the sensor 4 changes significantly as the end part 250. The controller 50 acquires a position 251 of the end part 250 intersecting with the line W1. The controller 50 calculates the coordinate values of the position 251 in each of the directions L, W, and Z, for example.

The controller 50 also calculates a roll angle γ of the inlet 210 based on the detection result of the sensor 4 along the line W1. As illustrated in FIG. 11, the roll angle γ is the tilt angle of the inlet 210 with respect to the second direction W. The roll angle γ is also the rotation angle of the vehicle 200 and the inlet 210 with the line in the first direction L being the center of rotation.

As illustrated in FIG. 12, a linear protrusion 260 is disposed in the inlet 210. The protrusion 260 extends along an insertion direction Ins along which the connector 5 is inserted into the inlet 210. The insertion direction Ins is the front-and-rear direction of the vehicle 200, for example. The insertion direction Ins is also the axial direction of the fitting part 230. The opening part 230b opens toward the insertion direction Ins. The protrusion 260 rises from the bottom face 220a of the base part 220 toward the lower side. The protrusion 260 extends from the end part 240 of the fitting part 230 in a direction away from the fitting part 230.

The protrusion 260 according to the present embodiment has a concavo-convex shape where a convex part 260a and a concave part 260b are alternately placed along the insertion direction Ins. The convex part 260a protrudes toward both sides of a width direction Wd. The width direction Wd is a direction orthogonal to the insertion direction Ins, and corresponds to the second direction W. The width direction Wd is the width direction of the vehicle 200, for example.

As illustrated in FIG. 3 and the like, the connector 5 includes a groove part 51 that is guided by the protrusion 260. The groove part 51 is disposed on a top face 5a of the connector 5. The top face 5a is the face opposing to the inlet 210 in the up-and-down direction Z. The connector 5 is fitted into the fitting part 230 with the top face 5a being slid against the bottom face 220a of the inlet 210.

The groove part 51 includes a first groove part 51a extending in a straight-line shape along the first direction L and a tapered second groove part 51b. The size of the width of the first groove part 51a corresponds to the size of the width of the protrusion 260. When the protrusion 260 is inserted into the first groove part 51a, the connector 5 is guided to the opening part 230b of the fitting part 230 along the insertion direction Ins.

The second groove part 51b is continuous with the first groove part 51a, and has a tapered shape where the width thereof becomes narrower as approaching the first groove part 51a along the first direction L. The second groove part 51b is disposed on the tip side in the insertion direction Ins with respect to the first groove part 51a. The second groove part 51b allows a tip 260c of the protrusion 260 to be guided into the first groove part 51a. The spread angle of the second groove part 51b is determined according to the maximum allowable value of the yaw angle α of the inlet 210. In other words, the second groove part 51b is configured to be able to house the protrusion 260 and guide the protrusion 260 into the first groove part 51a even when the yaw angle α is at the set maximum value.

The second groove part 51b has an entry part 51c opened toward the first direction L. The width of the second groove part 51b is the greatest at the entry part 51c. The groove part 51 has a central axis line Cx. When the connection mechanism 7 is in the neutral state, the central axis line Cx extends in the first direction L.

The controller 50 calculates the coordinate values of the protrusion 260 based on the coordinate values of the positions 241, 242, and 243 of the fitting part 230, the coordinate values of the position 251, the pitch angle β of the inlet 210, and the like. The controller 50 calculates the position of the tip 260c of the protrusion 260, for example. The controller 50 calculates the target position and the target angle of the connector 5 based on the coordinate values of the protrusion 260.

The target position of the connector 5 is the target position in each of the first direction L, the second direction W, and the up-and-down direction Z, for example. The target position of the connector 5 may also be the target position of a prescribed part in the connector 5. The prescribed part of the connector 5 is the position of the central axis line Cx in the second groove part 51b, for example. The prescribed part may also be a part where the entry part 51c intersects with the central axis line Cx.

The position of the connector 5 in the first direction L is controlled by the first drive mechanism 10. The position of the connector 5 in the second direction W is controlled by the second drive mechanism 20. The position of the connector 5 in the up-and-down direction Z is controlled by the third drive mechanism 30 and the fourth drive mechanism 40.

The target angle of the connector 5 is the target value of the angle θ of the connector 5. The target angle of the connector 5 is defined such that the top face 5a of the connector 5 can be in surface contact with the bottom face 220a of the inlet 210. The angle θ of the connector 5 is controlled by the fourth drive mechanism 40.

The controller 50 sets command values for each of the first drive mechanism 10, the second drive mechanism 20, the third drive mechanism 30, and the fourth drive mechanism 40 based on the target position and the target angle of the connector 5. The first motor 11 of the first drive mechanism 10 is rotated by a drive signal according to the command value to move the slide body 3 to the target position in the first direction L. The second motor 21 of the second drive mechanism 20 is rotated by a drive signal according to the command value to move the slide body 3 to the target position in the second direction W.

The third motor 31 of the third drive mechanism 30 is rotated by a drive signal according to the command value to move the support member 6 to the target position in the up-and-down direction Z. The fourth motor 41 of the fourth drive mechanism 40 is rotated by a drive signal according to the command value to set the angle θ of the connector 5 as the target angle.

FIG. 13 illustrates the connector 5 positioned at the target position. The inlet 210 illustrated in FIG. 13 is at the yaw angle α and tilted with respect to the first direction L and the second direction W. The entry part 51c of the groove part 51 is positioned at the tip 260c of the protrusion 260. The entry part 51c is opposing to the protrusion 260 in the first direction L. The entry part 51c is also opposing to the opening part 230b of the fitting part 230. The connector 5 is positioned such that the central axis line Cx of the groove part 51 and the central axis line of the protrusion 260 intersect at the entry part 51c. In FIG. 13, the connector 5 is in contact with the bottom face 220a of the base part 220. In other words, the angle θ of the connector 5 matches the pitch angle β of the inlet 210.

The controller 50 moves the connector 5 in the first direction L toward the fitting part 230 from the state illustrated in FIG. 13. The protrusion 260 enters the second groove part 51b of the connector 5. As the connector 5 moves further toward the fitting part 230, the protrusion 260 is guided into the first groove part 51a as illustrated in FIG. 14. The protrusion 260 guides the groove part 51 to change the posture of the connector 5. More specifically, the protrusion 260 causes the connector 5 to rotate such that the direction of the central axis line Cx of the groove part 51 is aligned with the insertion direction Ins. In the vehicle charging device 1 according to the present embodiment, the universal joint 71 of the connection mechanism 7 allows the connector 5 to rotate.

The connector 5 is inserted into the opening part 230b of the fitting part 230 while being guided by the protrusion 260. The vehicle charging device 1 according to the present embodiment further allows motions of the connector 5 to follow the fitting part 230 as the connector 5 is fitted into the fitting part 230. The controller 50 releases the brake of the second motor 21, when fitting the connector 5 into the fitting part 230. In a case where the second motor 21 has an electromagnetic brake, the electromagnetic brake is released. This allows the slide body 3 to move in the second direction W.

While guiding the connector 5, the protrusion 260 moves the connector 5 and the slide body 3 in the second direction W to allow the connector 5 to follow the fitting part 230. It is preferable for the protrusion 260 to guide the connector 5 until the terminal of the connector 5 is fitted to the terminal of the inlet 210. The protrusion 260 may guide the connector 5 until the connector 5 is fully fitted into the fitting part 230.

When fitting of the connector 5 into the inlet 210 is completed, the controller 50 starts charging the battery of the vehicle 200. When charging is completed, the controller 50 disconnects the connector 5 from the inlet 210. In that case, the controller 50 moves the connector 5 along the first direction L to pull the connector 5 out of the fitting part 230. At this time, the controller 50 moves the connector 5 in the first direction L with the brake of the second motor 21 being released. This makes it possible to smoothly disconnect the connector 5 from the inlet 210.

When the connector 5 is disconnected from the inlet 210, the controller 50 moves the connector 5 to the initial position. The initial position is the position where each part including the connector 5 is housed inside the casing 2 and covered by the covers 2a and 2b.

Note that the means by which the second drive mechanism 20 causes the connector 5 to follow the fitting part 230 is not limited to releasing the brake. For example, the second drive mechanism 20 may include the second motor 21, a ball screw driven by the second motor 21, and a spring. The ball screw extends in the second direction W. The second motor 21 moves the slide body 3 in the second direction W by rotating in the forward direction and the reverse direction. The spring is interposed between the ball screw and the slide body 3 or between the second motor 21 and the slide body 3 to allow the slide body 3 to move relative to the ball screw. Such a configuration allows the slide body 3 to oscillate in the second direction W by the external force the connector 5 receives from the inlet 210.

As described above, the vehicle charging device 1 according to the present embodiment includes the connector 5, the support member 6, the connection mechanism 7, the arm 8, the first drive mechanism 10, the second drive mechanism 20, the third drive mechanism 30, the fourth drive mechanism 40, the sensor 4, and the controller 50. The connector 5 is fitted into the inlet 210 disposed in the vehicle 200. The connector 5 includes the groove part 51 that is guided by the linear protrusion 260 provided in the inlet 210. The connection mechanism 7 connects the connector 5 to the support member 6, and allows changes in the posture of the connector 5. The arm 8 includes the first end part 81 connected to the support member 6, and the second end part 82 supported in a rotatable manner. The arm 8 moves the support member 6 up and down by rotating.

The first drive mechanism 10 is a mechanism that moves the arm 8 in the horizontal first direction L. The second drive mechanism 20 is a mechanism that moves the arm 8 in the horizontal second direction W. The third drive mechanism 30 is a mechanism that rotates the arm 8. The fourth drive mechanism 40 rotates the support member 6 so as to change the angle of the connector 5 with respect to the first direction L. The sensor 4 is a sensor that detects the inlet 210. The first direction L and the second direction W are orthogonal to each other.

The controller 50 calculates the position of the protrusion 260 in the first direction L, the second direction W, and the up-and-down direction Z based on the information acquired from the sensor 4. The controller 50 controls first drive mechanism 10, the second drive mechanism 20, the third drive mechanism 30, and the fourth drive mechanism 40 based on the calculated position of the protrusion 260 to fit the connector 5 into the inlet 210 along first direction L while inserting the protrusion 260 of the inlet 210 into the groove part 51 of the connector 5. The vehicle charging device 1 according to the present embodiment is capable of properly fitting the connector 5 into the inlet 210.

The controller 50 according to the present embodiment calculates the yaw angle α, the pitch angle β, and the roll angle γ of the inlet 210 based on the information acquired from the sensor 4. The controller 50 controls the first drive mechanism 10, the second drive mechanism 20, the third drive mechanism 30, and the fourth drive mechanism 40 based on the calculated position of the protrusion 260, the yaw angle α, the pitch angle β, and the roll angle γ. This enables highly precise fitting control.

The first direction L of the present embodiment corresponds to the front-and-rear direction of the vehicle 200, and it is also the fitting direction of the connector 5 with respect to the inlet 210. The second direction W corresponds to the width direction of the vehicle 200. The second drive mechanism 20 includes the second motor 21 that moves the arm 8 in the second direction W, and it is configured to allow the connector 5 to move in the second direction W while following the inlet 210 when the connector 5 is fitted into the inlet 210. Such a configuration allows the connector 5 to be properly fitted into the inlet 210.

The second motor 21 according to the present embodiment has a brake. The controller 50 releases the brake of the second motor 21, when the connector 5 is fitted into the inlet 210. This allows the connector 5 to be smoothly fitted into the inlet 210.

Note that the vehicle charging device 1 may not need to perform the scan in the second direction W. In that case, the position, the yaw angle α, the pitch angle β, and the roll angle γ of the inlet 210 are calculated based on the result of the scans performed in the first direction L.

In the vehicle charging device 1, the number, arrangement, and angles of the sensors 4 are not limited to the number, arrangement, and angles presented as examples. For example, the vehicle charging device 1 can acquire the position of the protrusion 260 as well as the yaw angle α, the roll angle γ, and the pitch angle β of the inlet 210 by at least a single sensor 4.

### First Modification Example of Embodiment

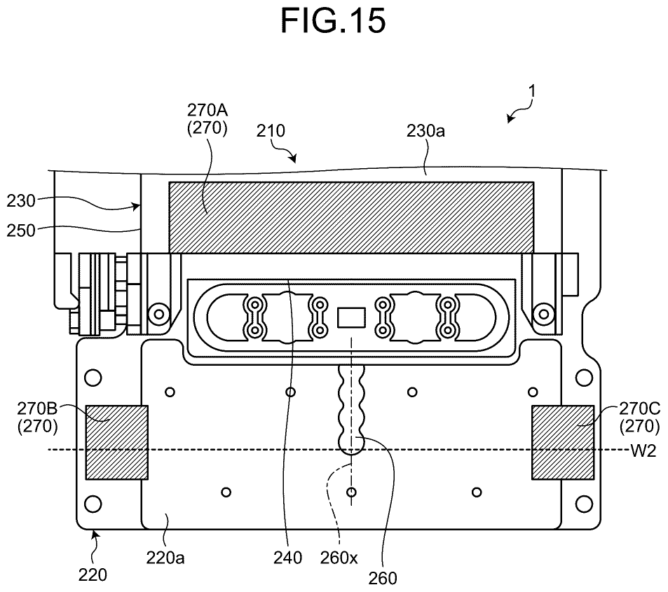

A first modification example of the embodiment will be described. FIG. 15 is a diagram of a vehicle charging device according to the first modification example of the embodiment. The vehicle charging device 1 according to the first modification example includes a reflection member 270 disposed in the inlet 210. The reflection member 270 has a reflective characteristic that reflects at least the laser beams LB1 and LB2. The reflection member 270 is configured to reflect the laser beams LB1, LB2 toward the direction of incidence of the laser beams LB1, LB2 to the reflection member 270. The reflection member 270 presented as an example is a reflective tape with an adhesive tape.

The reflection member 270 includes a first reflection member 270A, a second reflection member 270B, and a third reflection member 270C. The first reflection member 270A is disposed on the bottom face 230a of the fitting part 230. The first reflection member 270A is disposed in the vicinity of the end part 240 on the bottom face 230a. This improves the detection accuracy when the sensor 4 performs the scans along the lines L1, L2, and L3. For example, the amount of light received by the sensor 4 when scanning the first reflection member 270A is greater than the amount of light received by the sensor 4 when scanning a part different from the first reflection member 270A. Thereby, the end part 240 can be detected based on both the change in the distance detected by the sensor 4 and the change in the amount of light received by the sensor 4. This improves the detection accuracy of the end part 240.

The first reflection member 270A extends from one end of the bottom face 230a to the other end of the width direction Wd. This improves the detection accuracy when the sensor 4 performs the scan along the line W1. For example, the end part 250 of the fitting part 230 can be detected based on both the change in the distance detected by the sensor 4 and the change in the amount of light received by the sensor 4.

The second reflection member 270B and the third reflection member 270C are disposed on the base part 220 of the inlet 210. The second reflection member 270B and the third reflection member 270C are disposed on both sides of the width direction Wd with the protrusion 260 interposed therebetween. The two reflection members 270B and 270C are disposed at symmetrical positions about the central axis line 260x of the protrusion 260. The controller 50 of the first modification example sets a scan line W2 to intersect with the two reflection members 270B and 270C. This improves the detection accuracy for detecting the position of the protrusion 260.

### Second Modification Example of Embodiment

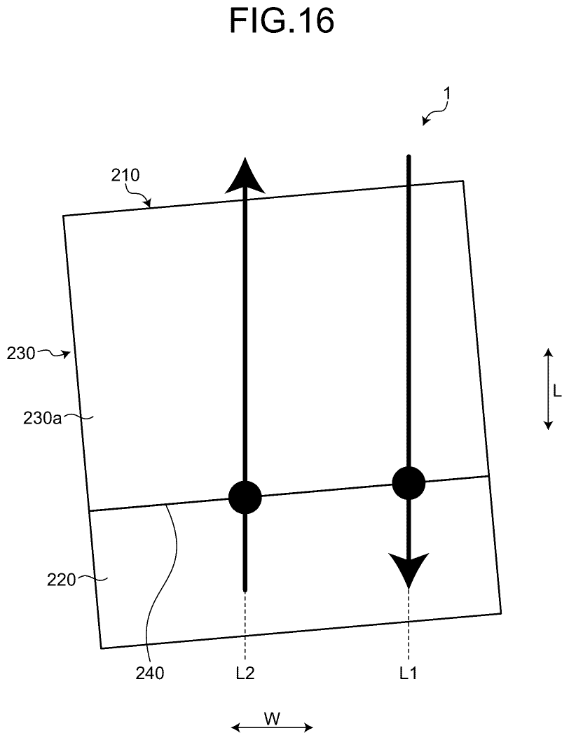

A second modification example of the embodiment will be described. FIG. 16 is a diagram illustrating scan lines according to the second modification example of the embodiment. The vehicle charging device 1 of the second modification example performs scans on a plurality of lines L1 and L2 along the first direction L by a single sensor 4. The lines L1 and L2 are set at different positions in the second direction W.

The controller 50 positions the sensor 4 on the first line L1 to scan the inlet 210 while moving the sensor 4 toward one side of the first direction L. Then, the controller 50 positions the sensor 4 on the second line L2 to scan the inlet 210 while moving the sensor 4 toward the other side of the first direction L. With such detection operations, the number of required sensors 4 can be reduced. This also makes it possible to scan more lines with the same number of sensors 4, which improves the detection accuracy of the end part 240.

### Third Modification Example of Embodiment

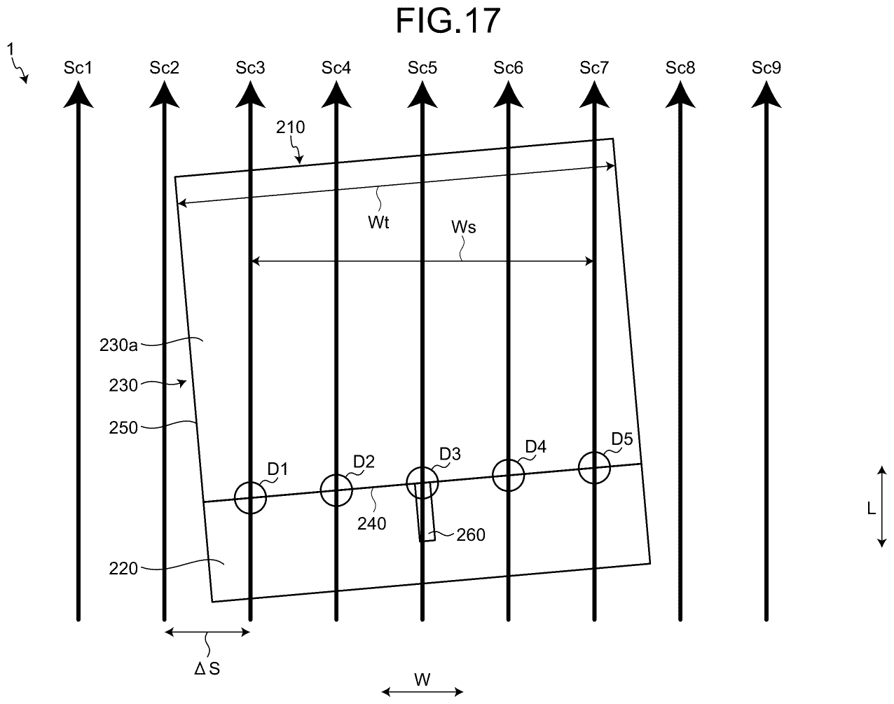

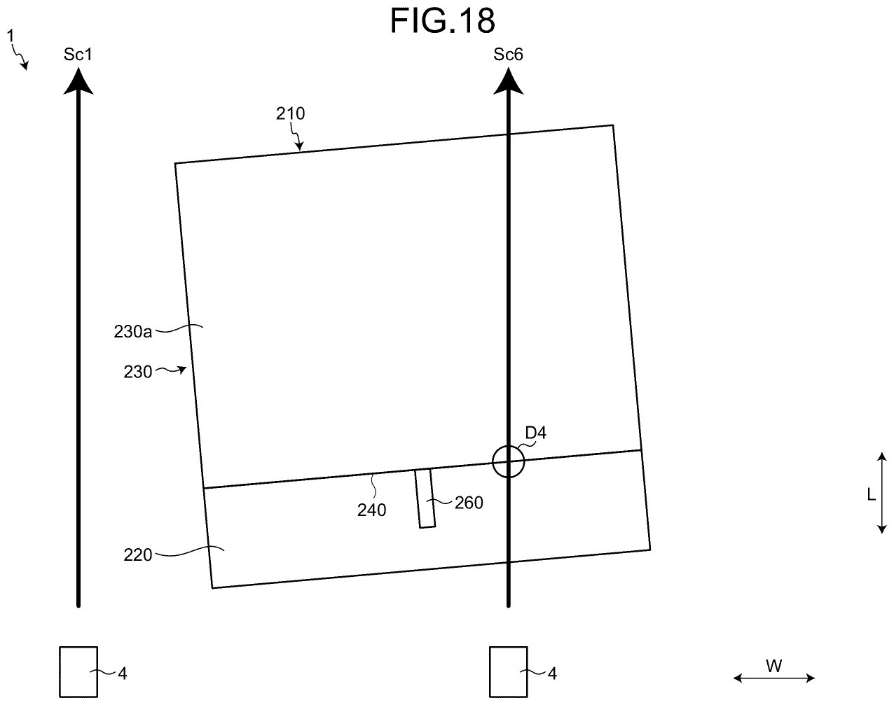

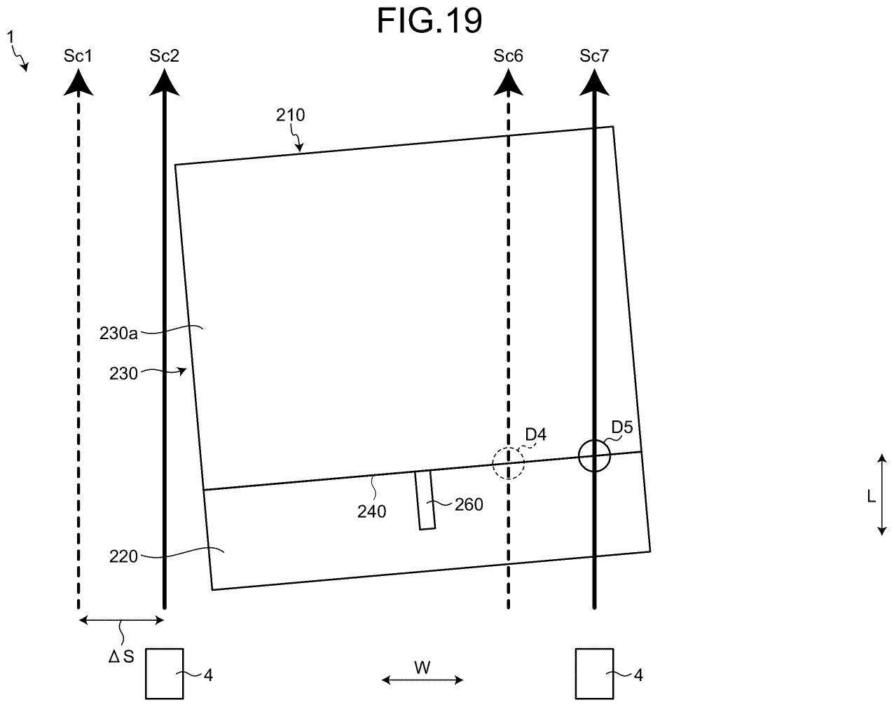

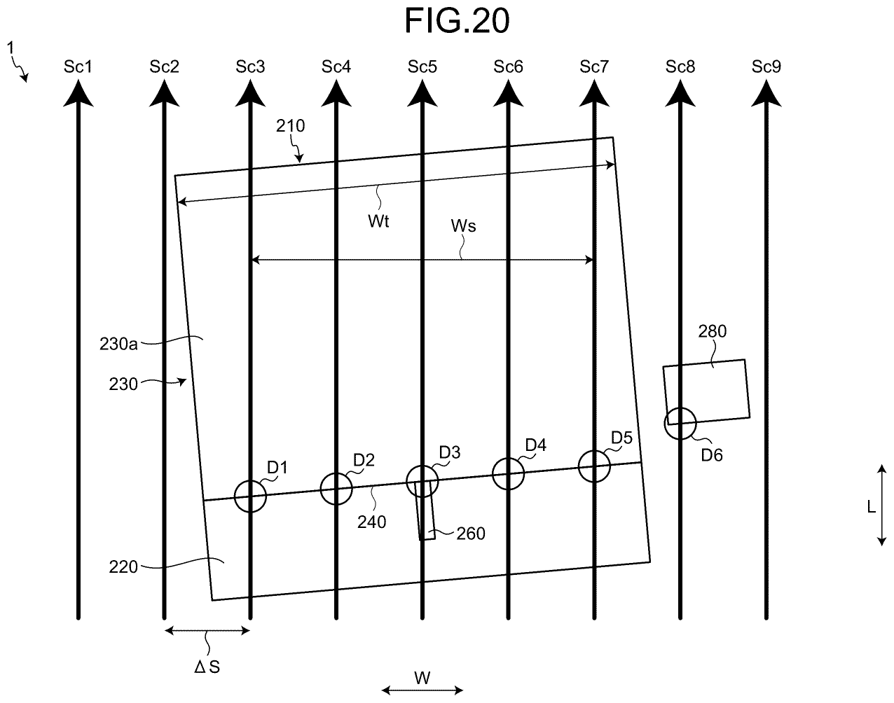

A third modification example of the embodiment will be described. FIG. 17 is a diagram for describing scan lines according to the third modification example of the embodiment, FIG. 18 is a diagram for describing a single scan, FIG. 19 is a diagram for describing a next scan, and FIG. 20 is a diagram illustrating detection points including a false detection point.

A controller 50 according to the third modification example of the embodiment sets a plurality of scan lines Sci (i=1, 2, 3, . . . ) extending in the first direction L. The sensor 4 detects the end part 240 of the fitting part 230 by performing scans along the lines Sci. The end part 240 has a straight-line shape that intersects with the first direction L. The lines Sci are equally spaced along the second direction W. Spacing ΔS between the lines Sci in the second direction W is set such that target number Nt of the lines Sci intersect with the end part 240 of the fitting part 230. In other words, the spacing ΔS is set such that the number of points at which the end part 240 is detected becomes equal to or greater than the target number Nt.

Note here that the target number Nt is an integer of 3 or greater, for example. The target number Nt may be 4 or may be 5. In the case of the scanning illustrated in FIG. 17, the spacing ΔS is set such that the five lines Sci intersect with the end part 240. By the scans performed along the lines Sci, a plurality of points Dj (j=1, 2, 3, . . . ) are detected as the end part 240. In FIG. 17, as a result of the scans, the end part 240 is detected at five points from point D1 to point D5.

The spacing ΔS between the scans is determined based on a set distance Ws in the second direction W. The set distance Ws is a length shorter than the width Wt of the fitting part 230, for example. The set distance Ws is defined to be able to secure the appropriate accuracy in detecting the position and the tilt of the end part 240. The spacing ΔS between the scans is a value acquired by equally dividing the set distance Ws. The spacing ΔS in FIG. 17 is the length acquired by equally dividing the set distance Ws into four. In other words, scans along the five lines Sci are performed within a range of the set distance Ws.

As illustrated in FIG. 17, a plurality of lines Sci (i=1, 2, 3, . . . ) including the target number Nt are set in the vehicle charging device 1. The positions of the lines Sci are positions relative to the position of the vehicle charging device 1, and are fixed positions, for example. The controller 50 performs the scans along the lines Sci by at least a single sensor 4. When there is a single sensor 4, the controller 50 performs scans in order from Sc1 to Sc2, Sc3, . . . Sci, for example. When there are two sensors 4 provided in the vehicle charging device 1, the controller 50 performs the scans on two lines among the lines Sci in a single scanning operation.

When there are a plurality of sensors 4, the spacing between two adjacent sensors 4 is defined in accordance with the spacing ΔS. It is supposed that the number of the sensors 4 is two and the number of lines Sci is ten (i=10). In that case, the spacing between the two sensors 4 is defined such that the line Sc1 and the line Sc6 can be scanned simultaneously as illustrated in FIG. 18, for example. In other words, the spacing between the two sensors 4 is five times the spacing ΔS between the scans. In FIG. 18, the end part 240 is not detected on the line Sc1, and the point D4 is detected by the scan on the line Sc6.

When a single scan is completed, the controller 50 moves the sensor 4 in the second direction W to perform the next scan. The next scan is performed for the line Sc2 and the line Sc7 as illustrated in FIG. 19, for example. The end part 240 is not detected on the line Sc2, and the point D5 is detected by the scan performed on the line Sc7. In the same manner, scans are sequentially performed for the line Sc3 and the line Sc8, for the line Sc4 and the line Sc9, and for the line Sc5 and the line Sc10. The direction of movement of the sensor 4 in all scans is the same direction of the first direction L. This suppresses deterioration in the positional accuracy due to backlash and the like of the first drive mechanism 10.

The controller 50 ends the process of detecting the end part 240, when the scans for all lines Sci are performed, for example. The condition for ending the process of detecting the end part 240 is not limited to the fact that the scans for all lines Sci are performed. The controller 50 may end the process of detecting the end part 240 when the number of points at which the end part 240 is detected reaches the required number of points.

The controller 50 verifies whether the points detected as the end part 240 satisfy a prescribed condition. The prescribed condition is a condition to check whether a part different from the end part 240 is falsely detected as the end part 240. In the vicinity of the inlet 210 in the vehicle 200, there may be a step formed due to other devices, members, and the like. When such a step is falsely detected as the end part 240, it is desirable to be able to eliminate the falsely detected point.

The prescribed condition includes a condition that a plurality of detected points are on the same straight line. This determination is made by calculation based on the coordinate values in the first direction L, the coordinate values in the second direction W, and the coordinate values in the up-and-down direction Z of each of the detected points. Any methods may be used for calculating the straight line. For example, the straight line may be acquired by the least-squares method from all detected points. In that case, whether each point is on the calculated straight line may be determined based on the distance between the calculated straight line and each point.

The straight line may be acquired from a plurality of detected points from which the determination target point is excluded, for example. In that case, whether the determination target point is on the calculated straight line may be determined based on the distance between the calculated straight line and the determination target point.

When determined that any of the detected points is not on the same straight line, the controller 50 may perform the scan for the end part 240 again. When determined that any of the detected points is not on the same straight line, the controller 50 may extract the points that are determined to be on the same straight line. In that case, the controller 50 may calculate the position and the like of the end part 240 based on the extracted points. It is preferable that there be three or more points determined to be on the same straight line. The lines Sci illustrated in FIG. 17 are set to be able to detect five points of the end part 240 such that sufficient number of points can be secured on the same straight line even if there is a false detection.

The controller 50 calculates the edge line of the end part 240 based on the points determined to be on the same straight line. The controller 50 of the third modification example calculates the edge line based on the coordinate values of the two points at both ends among the points determined to be on the same straight line. Referring to FIG. 17, the way of acquiring the edge line will be described. As illustrated in FIG. 17, it is supposed that the five points from the point D1 to the point D5 are calculated as the end part 240. When determined that all points from the point D1 to the point D5 are on the same straight line, the controller 50 calculates the edge line of the end part 240 based on the point D1 and the point D5 at both ends. The controller 50 calculates the straight line of the edge line of the end part 240 based on the coordinate values in the first direction L, the coordinate values in the second direction W, and the coordinate values in the up-and-down direction Z of the points D1 and D5. Use of the point D1 and the point D5 at both ends improves the calculation accuracy of the edge line.

FIG. 20 illustrates a state where another device 280 is falsely detected as the end part 240. The point D6 is the point where the step of another device 280 is falsely detected as the end part 240. The position of the point D6 is shifted with respect to the edge of the end part 240. In this case, the straight line is determined by the dominant five points D1, D2, D3, D4, and D5 in straight line approximation, excluding the point D6. As a result, it is determined that the point D6 is not on the calculated straight line. Among the detected points D1 to D6, the controller 50 selects the points D1 and D5 at both ends from the five points excluding the point D6, and calculates the edge line based on the points D1 and D5.

After the process of detecting the end part 240 ends, the process of detecting the end part 250 of the fitting part 230 is executed by performing the scan in the second direction W. The process of detecting the end part 250 may be the same as the content described in the above embodiment.

The controller 50 calculates the coordinate values of the protrusion 260 based on the calculated position of the end part 240 and the calculated position of the end part 250. The method for calculating the coordinate values of the protrusion 260 may be the same as that of the embodiment described above. According to the third modification example, it is possible to improve the detection accuracy for detecting the end part 240. This also improves the accuracy for detecting the position and posture of the inlet 210.

As described above, the fitting part 230 of the inlet 210 includes a straight-line shape end part 240 that intersects with the first direction L. The sensor 4 detects the end part 240 of the fitting part 230 by performing scans along the lines Sci (i=1, 2, 3, . . . ) extending in the first direction L. The lines Sci are equally spaced along the second direction W. The spacing ΔS between the lines Sci in the second direction W is set such that at least three lines Sci intersect with the end part 240 of the fitting part 230. The controller 50 calculates the position of the protrusion 260 based on the detected position of the end part 240. With such a configuration, the detection accuracy of the end part 240 is improved.

The controller 50 of the third modification example extracts a plurality of points on the same straight line from the points Dj (j=1, 2, 3, . . . ) detected by the sensor 4 as the end part 240 of the fitting part 230. The controller 50 calculates the position of the end part 240 of the fitting part 230 based on the coordinate values of the points at both ends among the extracted points. Such a calculation method makes it possible to calculate the position and the tilt of the end part 240 with high accuracy. Note that the position of the end part 240 calculated herein may be a provisional position. In that case, the position of the end part 240 may be determined finally based on the position of the end part 250 detected by the scan performed in the second direction W.

The contents disclosed in the embodiment and the modification examples described above can be combined and implemented as appropriate.

In the vehicle charging device according to the present embodiment, the controller calculates the position of the protrusion in the first direction, the second direction, and the up-and-down direction based on the information acquired from the sensor. The controller controls the first drive mechanism, the second drive mechanism, the third drive mechanism, and the fourth drive mechanism based on the calculated position of the protrusion to fit the connector into the inlet along first direction while inserting the protrusion of the inlet into the groove part of the connector. According to the vehicle charging device of the present embodiment, it is possible to properly fit the connector to the inlet of the vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle charging device comprising:
a connector that includes a groove part guided by a linear protrusion provided to an inlet disposed in a vehicle, the connector being fitted into the inlet;
a support member;
a connection mechanism that connects the connector and the support member, and allows a change in a posture of the connector;
an arm that includes a first end part connected to the support member and a second end part supported in a rotatable manner, the arm moving up and down the support member by rotating;
a first drive mechanism that moves the arm in a horizontal first direction;
a second drive mechanism that moves the arm in a horizontal second direction;
a third drive mechanism that rotates the arm;
a fourth drive mechanism that rotates the support member so as to change an angle of the connector with respect to the first direction;
a sensor that detects the inlet; and
a controller, wherein
the first direction and the second direction are orthogonal to each other,
the controller calculates a position of the protrusion in the first direction, the second direction, and an up-and-down direction based on information acquired from the sensor, and
the controller controls the first drive mechanism, the second drive mechanism, the third drive mechanism, and the fourth drive mechanism based on the calculated position of the protrusion to fit the connector into the inlet along the first direction while inserting the protrusion of the inlet into the groove part of the connector.

2. The vehicle charging device according to claim 1, wherein
the controller calculates a yaw angle, a pitch angle, and a roll angle of the inlet based on the information acquired from the sensor, and
the controller controls the first drive mechanism, the second drive mechanism, the third drive mechanism, and the fourth drive mechanism based on the calculated position of the protrusion, the yaw angle, the pitch angle, and the roll angle.

3. The vehicle charging device according to claim 1, wherein
the first direction corresponds to a front-and-rear direction of the vehicle, the first direction also being a fitting direction of the connector with respect to the inlet,
the second direction corresponds to a width direction of the vehicle, and
the second drive mechanism includes a motor that moves the arm in the second direction, the second mechanism being configured to allow the connector to move in the second direction while following the inlet when the connector is fitted into the inlet.

4. The vehicle charging device according to claim 3, wherein
the motor of the second drive mechanism includes a brake, and
the controller releases the brake of the motor of the second drive mechanism, when the connector is fitted into the inlet.

5. The vehicle charging device according to claim 1, wherein
the inlet includes a fitting part where the connecter is fitted,
the fitting part includes a straight-line shape end part that intersects with the first direction,
the sensor detects the end part of the fitting part by a scan performed along a plurality of lines extending in the first direction,
the lines are equally spaced in the second direction,
spacing between the lines in the second direction is set such that at least three of the lines intersect with the end part of the fitting part, and
the controller calculates the position of the protrusion based on a position of the detected end part.

6. The vehicle charging device according to claim 5, wherein
the controller extracts a plurality of points on a same straight line from points detected by the sensor as the end part of the fitting part, and
the controller calculates the position of the end part of the fitting part based on coordinate values of points at both ends among the extracted points.
